(19) United States
(12) Patent Application Publication
(10) Pub. No.: US 2026/0169183 A1
(43) Pub. Date: Jun. 18, 2026

(54) SEISMIC BLIND INVERSION METHOD AND APPARATUS, ELECTRONIC DEVICE AND COMPUTER-READABLE STORAGE MEDIUM

(71) Applicant: INSTITUTE OF GEOLOGY AND GEOPHYSICS, CHINESE ACADEMY OF SCIENCES, Beijing (CN)

(72) Inventor: Yanfei Wang, Beijing (CN)

(21) Appl. No.: 19/249,360

(22) Filed: Jun. 25, 2025

(30) Foreign Application Priority Data
Jun. 26, 2024 (CN) 202410831631.1

(51) Int. Cl. G01V 1/30

(52) U.S. Cl. CPC G01V 1/306

(57) ABSTRACT

The present disclosure provides a method and an apparatus for simultaneous inversion of seismic reflection coefficients and seismic wavelets, relating to the technical field of seismic inversion. The method includes: acquiring seismic recording data of a specified work area, and performing position encoding on the seismic recording data to obtain target seismic recording data; extracting temporal and spatial characteristics of the target seismic recording data to obtain temporal and spatial characteristics of seismic wavelets and temporal and spatial characteristics of seismic reflection coefficients within the specified work area; decoding the above temporal and spatial characteristics respectively to obtain the seismic reflection coefficients and the seismic wavelets of the specified work area.

### CROSS-REFERENCE TO RELATED APPLICATIONS

The present disclosure claims the priority to the Chinese patent application with the filing No. 202410831631.1 filed with the Chinese Patent Office on Jun. 26, 2024, the contents of which are incorporated herein by reference in entirety.

### TECHNICAL FIELD

The present disclosure relates to the technical field of seismic inversion, and in particular, to a method and an apparatus for simultaneous inversion of seismic reflection coefficients and seismic wavelets (seismic blind inversion method and apparatus).

### BACKGROUND ART

From the perspective of seismic data processing, an inversion technology of seismic reflection coefficients broadens frequency spectrum and increases dominant frequency based on effective data acquisition. Moreover, reflection coefficients are also a critical step in wave impedance inversion. Traditional inversion of seismic reflection coefficients requires prior assumptions about seismic wavelets before the inversion of the reflection coefficients. However, in non-stationary scenarios, the construction of the seismic wavelets is difficult, and an accuracy of constructed results is difficult to guarantee, resulting in an inversion accuracy of seismic reflection coefficients failing to meet requirements of fine exploration.

### SUMMARY

The objective of the present disclosure is to provide a method and an apparatus for simultaneous inversion of seismic reflection coefficients and seismic wavelets, thereby solving the technical problem of low inversion accuracy of existing inversion methods of seismic reflection coefficients.

In a first aspect, the present disclosure provides a method for simultaneous inversion of seismic reflection coefficients and seismic wavelets, which is applied to an improved Transformer network model. The improved Transformer network model includes an input layer, an encoder component, and a seismic reflection coefficient decoder component and a seismic wavelet decoder component arranged in parallel. The method includes: acquiring, by the input layer, seismic recording data of a specified work area, and performing, by the input layer, position encoding on the seismic recording data to obtain target seismic recording data; extracting, by the encoder component, temporal and spatial characteristics of the target seismic recording data to obtain temporal and spatial characteristics of seismic wavelets and temporal and spatial characteristics of seismic reflection coefficients within the specified work area; decoding, by the seismic reflection coefficient decoder component, the temporal and spatial characteristics of the seismic reflection coefficients to obtain the seismic reflection coefficients of the specified work area; and decoding, by the seismic wavelet decoder component, the temporal and spatial characteristics of the seismic wavelets to obtain the seismic wavelets of the specified work area.

In an optional embodiment, the method further includes: acquiring a training sample set, the training sample set including a plurality of training samples, each training sample including sample seismic recording data, sample seismic reflection coefficients, and a sample seismic wavelet, the sample seismic recording data being a result obtained by convolution based on the sample seismic reflection coefficients and the sample seismic wavelet; processing sample seismic recording data in a target training sample using an initial neural network model to obtain predicted seismic reflection coefficients and a predicted seismic wavelet, the target training sample representing any training sample in the training sample set; convolving the predicted seismic reflection coefficients and the predicted seismic wavelet to obtain synthetic seismic recording data; calculating a loss function value of a preset loss function based on the target training sample, the predicted seismic reflection coefficients, the predicted seismic wavelet, and the synthetic seismic recording data; and training the initial neural network model based on the loss function value until a preset termination condition is met, so as to obtain the improved Transformer network model.

In an optional embodiment, calculating the loss function value of the preset loss function based on the target training sample, the predicted seismic reflection coefficients, the predicted seismic wavelet, and the synthetic seismic recording data includes: calculating a mean squared error between the predicted seismic reflection coefficients and the sample seismic reflection coefficients in the target training sample to obtain a first error; calculating a mean squared error between the predicted seismic wavelet and the sample seismic wavelet in the target training sample to obtain a second error; calculating a mean squared error between the synthetic seismic recording data and the sample seismic recording data in the target training sample to obtain a third error; and calculating the loss function value of the preset loss function based on the first error, the second error, and the third error.

In an optional embodiment, the preset loss s function is expressed as: loss(s, r, w, r_{Label}, w_{Label})=λMSE(r, r_{Label})+μMSE(w, w_{Label})+φMSE(s, input), where s represents the synthetic seismic recording data, input represents the sample seismic recording data, r represents the predicted seismic reflection coefficients, r_{Label} represents the sample seismic reflection coefficients, w represents the predicted seismic wavelet, w_{Label} represents the sample seismic wavelet, MSE( ) represents a mean squared error loss function, and λ, μ, and φ all represent preset weight coefficients.

In an optional embodiment, the sample seismic recording data in the training sample set includes following two types: stationary seismic recording data and non-stationary seismic recording data.

In an optional embodiment, a convolution model for the stationary seismic recording data is expressed as: input₁(t)=w(t)*r(t)+n(t), where input₁(t) represents the stationary seismic recording data, r(t) represents the sample seismic reflection coefficients, w(t) represents the sample seismic wavelet, and n represents additive noise. A convolution model for the non-stationary seismic recording data is expressed as:

$${input}_{2} ( t ) = {\int }_{0}^{+ ∞} r ( τ ) \frac{1}{2 π} {\int }_{- ∞}^{+ ∞} W ( f ) α ( τ , f ) {e}^{2 π if ( t - τ )} dfd τ ,$$

where input₂(t) represents the non-stationary seismic recording data, r(τ) represents seismic reflection coefficients at time τ in the sample seismic reflection coefficients, W(f) represents a Fourier transform of the sample seismic wavelet w(t), f represents frequency, α(τ, f) represents an attenuation function,

$$α ( τ , f ) = {e}^{- π f {\int }_{0}^{τ} \frac{1}{Q ( t )} dt} ,$$

Q(t) represents a stratum attenuation factor at time t, and i represents an imaginary unit.

In a second aspect, the present disclosure provides an apparatus for simultaneous inversion of seismic reflection coefficients and seismic wavelets. The apparatus includes: a first acquisition module, configured to acquire seismic recording data of a specified work area and perform position encoding on the seismic recording data to obtain target seismic recording data; an encoding module, configured to extract temporal and spatial characteristics of the target seismic recording data to obtain temporal and spatial characteristics of seismic wavelets and temporal and spatial characteristics of seismic reflection coefficients within the specified work area; a first decoding module, configured to decode the temporal and spatial characteristics of the seismic reflection coefficients to obtain the seismic reflection coefficients of the specified work area; and a second decoding module, configured to decode the temporal and spatial characteristics of the seismic wavelets to obtain the seismic wavelets of the specified work area.

In an optional embodiment, the apparatus further includes: a second acquisition module, configured to acquire a training sample set, the training sample set including a plurality of training samples, each training sample including sample seismic recording data, sample seismic reflection coefficients, and a sample seismic wavelet, the sample seismic recording data being a result obtained by convolution based on the sample seismic reflection coefficients and the sample seismic wavelet; a processing module, configured to process sample seismic recording data in a target training sample using an initial neural network model to obtain predicted seismic reflection coefficients and a predicted seismic wavelet, the target training sample representing any training sample in the training sample set; a convolution module, configured to convolve the predicted seismic reflection coefficients and the predicted seismic wavelet to obtain synthetic seismic recording data; a calculation module, configured to calculate a loss function value of a preset loss function based on the target training sample, the predicted seismic reflection coefficients, the predicted seismic wavelet, and the synthetic seismic recording data; and a training module, configured to train the initial neural network model based on the loss function value until a preset termination condition is met, so as to obtain an improved Transformer network model.

In a third aspect, the present disclosure provides an electronic device. The electronic device includes a memory and a processor. The memory stores a computer program that is able to run on the processor. The processor implements the steps of the method for simultaneous inversion of seismic reflection coefficients and seismic wavelets in any one of the above embodiments when executing the computer program.

In a fourth aspect, the present disclosure provides a computer-readable storage medium storing computer instructions that, when executed by a processor, implement the method for simultaneous inversion of seismic reflection coefficients and seismic wavelets in any one of the above embodiments.

The present disclosure provides a method for simultaneous inversion of seismic reflection coefficients and seismic wavelets. In this method, the seismic recording data of the specified work area is processed using the improved Transformer network model. Since the model is provided with the seismic reflection coefficient decoder component and the seismic wavelet decoder component arranged in parallel after the encoder component, in the present disclosure, the seismic reflection coefficients and the seismic wavelets of the specified work area are able to be simultaneously derived through inversion. Considering that no prior assumptions about the seismic wavelets are required before inversion, the problem of error accumulation is avoided, thereby effectively solving the technical problem of low inversion accuracy of seismic reflection coefficients in the prior art.

### BRIEF DESCRIPTION OF DRAWINGS

To more clearly illustrate the specific embodiments of the present disclosure or the technical solutions in the prior art, the drawings required for describing the specific embodiments or the prior art will be briefly introduced below. Obviously, the drawings described below are some embodiments of the present disclosure. Other drawings can also be obtained by those of ordinary skill in the art without creative efforts based on these drawings.

FIG. 1 is a schematic diagram of a network structure of an improved Transformer network model provided in an embodiment of the present disclosure;

FIG. 2 is a flowchart of a method for simultaneous inversion of seismic reflection coefficients and seismic wavelets provided in an embodiment of the present disclosure;

FIG. 3 is a schematic diagram of a training sample provided in an embodiment of the present disclosure;

FIG. 4 is a schematic comparison diagram of seismic reflection coefficients obtained after inverting single-trace stationary seismic recording data;

FIG. 5 is a schematic comparison diagram of seismic wavelets obtained after inverting single-trace stationary seismic recording data;

FIG. 6 is a schematic comparison diagram of seismic reflection coefficients obtained after inverting single-trace non-stationary seismic recording data;

FIG. 7 is a schematic comparison diagram of seismic wavelets obtained after inverting single-trace non-stationary seismic recording data;

FIG. 8 is a schematic diagram of seismic reflection coefficients generated by Marmousi model;

FIG. 9 is a schematic diagram of sample seismic recording data obtained by convolving the seismic reflection coefficients in FIG. 8;

FIG. 10 is a schematic diagram of predicted seismic reflection coefficients output after inverting FIG. 9 using the ADMM method;

FIG. 11 is a schematic diagram of predicted seismic reflection coefficients output after inverting FIG. 9 using the method provided in the embodiment of the present disclosure;

FIG. 12 is a schematic comparison diagram of seismic wavelets obtained after inverting FIG. 9;

FIG. 13 is a diagram shows functional modules of an apparatus for simultaneous inversion of seismic reflection coefficients and seismic wavelets provided in an embodiment of the present disclosure;

FIG. 14 is a schematic diagram of an electronic device provided in an embodiment of the present disclosure.

### DETAILED DESCRIPTION OF EMBODIMENTS

To make the objectives, technical solutions, and advantages of the embodiments of the present disclosure clearer, the technical solutions in the embodiments of the present disclosure will be described clearly and completely below in combination with the drawings in the embodiments of the present disclosure. Obviously, the described embodiments are part of the embodiments of the present disclosure, not all of them. Usually, the components of the embodiments of the present disclosure described and shown in the drawings herein can be arranged and designed in various different configurations.

Therefore, the following detailed description of the embodiments of the present disclosure provided in the drawings is not intended to limit the scope of the claimed present disclosure, but only represents the selected embodiments of the present disclosure. Based on the embodiments in the present disclosure, all other embodiments obtained by those of ordinary skill in the art without creative efforts belong to the protection scope of the present disclosure.

Some embodiments of the present disclosure are described in detail below with reference to the drawings. The following embodiments and features in the embodiments may be combined with each other without conflict.

### Embodiment 1

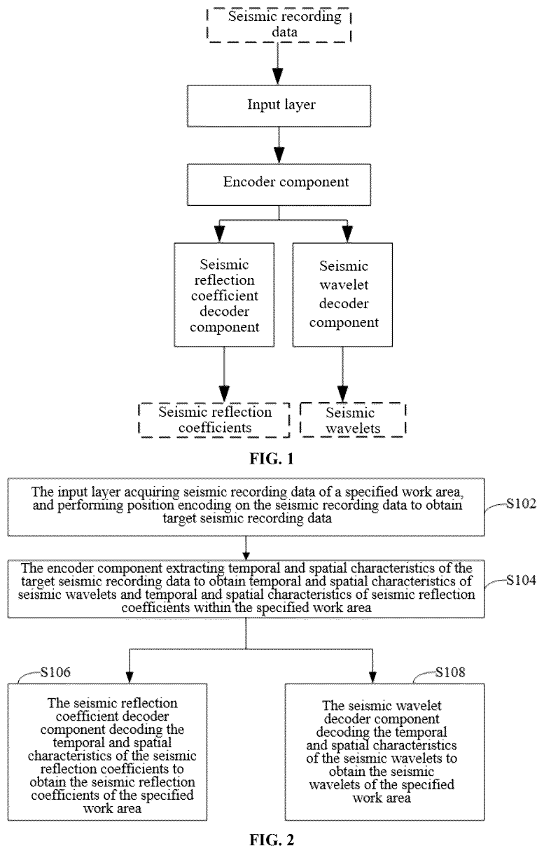

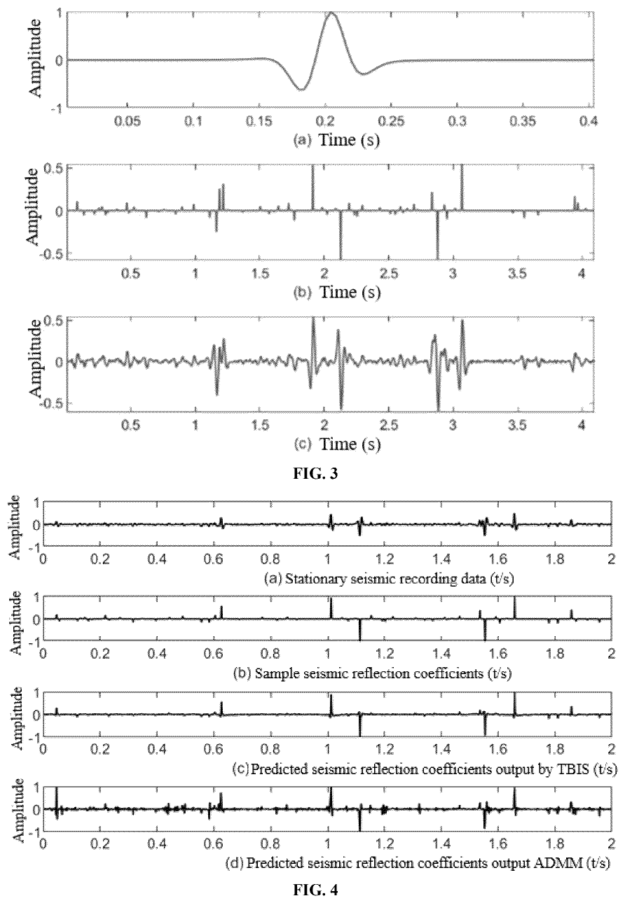

The embodiment of the present disclosure provides a method for simultaneous inversion of seismic reflection coefficients and seismic wavelets, and the method is applied to an improved Transformer network model. As shown in FIG. 1, the improved Transformer network model includes an input layer, an encoder component, and a seismic reflection coefficient decoder component and a seismic wavelet decoder component arranged in parallel. FIG. 2 is a flowchart of a method for simultaneous inversion of seismic reflection coefficients and seismic wavelets provided in an embodiment of the present disclosure. As shown in FIG. 2, the method specifically includes following steps.

In step S102, the input layer acquires seismic recording data of a specified work area and performs position encoding on the seismic recording data to obtain target seismic recording data.

Specifically, in the embodiment of the present disclosure, the improved Transformer network model is utilized to simultaneously invert the seismic reflection coefficients and the seismic wavelets. It is known that the Transformer network model processes sequential data through a self-attention mechanism but does not inherently consider an order of elements. However, the order of elements in the seismic recording data is crucial for understanding temporal and spatial characteristics of seismic data. Therefore, before extracting the temporal and spatial characteristics of the seismic recording data using an encoder, it is necessary to first perform the position encoding on the seismic recording data of the specified work area through the input layer.

The position encoding provides a method to maintain information of an order of elements in a sequence. Performing the position encoding on the seismic recording data may be understood as assigning each seismic data point a specific position identifier. The purpose of this is to enable the improved Transformer network model to understand relative positions and order of seismic data points, thereby capturing temporal dependencies in the seismic data.

In an embodiment, performing the position encoding on the seismic recording data specifically involves: processing the seismic recording data using a preset mathematical function, where the preset mathematical function is a combination of sine and cosine functions. These functions are able to generate periodic patterns, thereby providing unique encodings for elements at different positions.

In step S104, the encoder component extracts temporal and spatial characteristics of the target seismic recording data to obtain temporal and spatial characteristics of seismic wavelets and temporal and spatial characteristics of seismic reflection coefficients within the specified work area.

The encoder component includes a plurality of encoders with the same structure. Similar to a traditional Transformer network model, each encoder includes two sub-layers. A first sub-layer employs a multi-head self-attention mechanism, and a second sub-layer is a feedforward network composed of fully connected layers. Moreover, the two sub-layers incorporate a short-cut structure of a residual network to address a degradation issue in a deep neural network, and a normalization operation is added after each sub-layer. In the embodiment of the present disclosure, the number of encoders in the encoder component is not specifically limited, and a user can set it according to actual conditions. Optionally, the number of encoders is 2.

After the encoder component processes the target seismic recording data, a series of continuous hidden states may be obtained. These hidden states capture temporal and spatial characteristics of the seismic wavelets and the seismic reflection coefficients of the input data, and represent context-dependent representations of each position in the seismic recording data. In the embodiment of the present disclosure, the encoder component outputs the temporal and spatial characteristics of the seismic wavelets and the temporal and spatial characteristics of the seismic reflection coefficients.

In step S106, the seismic reflection coefficient decoder component decodes the temporal and spatial characteristics of the seismic reflection coefficients to obtain the seismic reflection coefficients of the specified work area.

In step S108, the seismic wavelet decoder component decodes the temporal and spatial characteristics of the seismic wavelets to obtain the seismic wavelets of the specified work area.

In the embodiment of the present disclosure, the traditional Transformer network model (1 encoder component+1 decoder component) is improved. Specifically, a decoder component is added in parallel with an existing decoder component to obtain the seismic wavelet decoder component and the seismic reflection coefficient decoder component arranged in parallel. Outputs of these two decoder components are outputs of the improved Transformer network model.

Specifically, each decoder component includes a plurality of decoders with the same structure. Similar to the traditional Transformer network model, each decoder includes three sub-layers: a masked multi-head self-attention mechanism layer, an encoder-decoder attention mechanism layer, and a feedforward neural network layer.

The masked multi-head self-attention mechanism layer allows a decoder to view all previous positions when generating an output at a current position, but prohibits viewing future positions to prevent information leakage. Such a mechanism ensures that an output at each position only depends on already generated parts rather than future parts during a generation process. The encoder-decoder attention mechanism layer allows a decoder to focus on relevant information output from the encoder, enabling use of this information during a decoding process. This attention mechanism helps the decoder understand contextual information provided by the encoder, thereby generating more accurate outputs. The feedforward neural network layer is used to perform a nonlinear transformation on a contextual representation of each position to extract more complex characteristics and enhance the expressive capability of the model. Similar to the encoder, the decoder incorporates a short-cut connection of a residual network around each sub-layer and then performs a layer normalization. In the embodiment of the present disclosure, the number of decoders in the decoder component is not specifically limited, and the user can set it according to actual conditions. Optionally, the number of decoders is 2.

The embodiment of the present disclosure provides the method for simultaneous inversion of seismic reflection coefficients and seismic wavelets. In this method, the seismic recording data of the specified work area is processed using the improved Transformer network model. Since the model is provided with the seismic reflection coefficient decoder component and the seismic wavelet decoder component arranged in parallel after the encoder component, in the embodiment of the present disclosure, the seismic reflection coefficients and the seismic wavelets of the specified work area are able to be simultaneously derived through inversion. Considering that no prior assumptions about the seismic wavelets are required before inversion, the problem of error accumulation is avoided, thereby effectively solving the technical problem of low inversion accuracy of seismic reflection coefficients in the prior art.

The above describes the processing flow of the improved Transformer network model for the seismic recording data. The following is a detailed introduction to a method for obtaining the improved Transformer network model through training. In an optional implementation, the method of the present disclosure further includes following steps.

In step S201, a training sample set is acquired.

The training sample set includes a plurality of training samples, and each training sample includes sample seismic recording data, sample seismic reflection coefficients, and a sample seismic wavelet. The sample seismic recording data is a result obtained by convolution based on the sample seismic reflection coefficients and the sample seismic wavelet.

In the embodiment of the present disclosure, the sample seismic reflection coefficients are regarded as seismic reflection coefficient labels in model training, and the sample seismic wavelet is regarded as a seismic wavelet label in model training. When constructing a training sample, the sample seismic wavelet may be exemplarily selected as Ricker wavelets of 15-55 Hz, with intervals of 0.2 Hz, and the wavelet is rotated by 0-40° in phase, with intervals of 0.1°, to generate more data with different stratum dip angles. The sample seismic reflection coefficients may be generated using Marmousi model. For example, sequences of seismic reflection coefficients are generated at incident angles of 0°, 6°, 12°, 18°, 24°, and 30°, respectively.

After determining a set of sample seismic reflection coefficients and a sample seismic wavelet, corresponding sample seismic recording data may be obtained through convolution. FIG. 3 is a schematic diagram of a training sample provided in an embodiment of the present disclosure. In FIG. 3, view (a) shows a sample seismic wavelet, view (b) shows sample seismic reflection coefficients, and view (c) shows sample seismic recording data. Based on a plurality of sets of sample seismic reflection coefficients and sample seismic wavelets, a large number of labeled training samples may be generated to obtain the training sample set.

In step S202, sample seismic recording data in a target training sample is processed using an initial neural network model to obtain predicted seismic reflection coefficients and a predicted seismic wavelet.

The target training sample represents any training sample in the training sample set.

In step S203, the predicted seismic reflection coefficients and the predicted seismic wavelet are convolved to obtain synthetic seismic recording data.

In other words, the improved Transformer network model further includes a forward model layer. During training of the initial neural network model, the forward model layer is used to convolve predicted seismic reflection coefficients and a predicted seismic wavelet output from two decoder components arranged in parallel, so as to generate synthetic seismic recording data. Obviously, this forward model layer is constructed based on physical principles. Therefore, the network has a strong generalization ability, and is a deep learning technology constrained by the physical principles.

In step S204, a loss function value of a preset loss function is calculated based on the target training sample, the predicted seismic reflection coefficients, the predicted seismic wavelet, and the synthetic seismic recording data.

In step S205, the initial neural network model is trained based on the loss function value until a preset termination condition is met, so as to obtain the improved Transformer network model.

The target training sample is real data input to the model, and the predicted seismic reflection coefficients, the predicted seismic wavelet, and the synthetic seismic recording data are predicted data output from the model. Therefore, in the embodiment of the present disclosure, the loss function value of the preset loss function is calculated based on the real data and the predicted data.

For example, the training samples in the generated training sample set may be divided into a training set, a validation set, and a test set at a ratio of 5:1:1. A magnitude of a Batch is selected as 10, a Learning Rate is selected as 1e-3, and a Dropout rate is selected as 0.2. An Adam optimization method is used to iteratively optimize the preset loss function until the preset termination condition is met. For example, when a preset training step size is reached, or the loss function value is less than a preset threshold and reaches a stable state, the training is terminated to obtain the improved Transformer network model.

In an optional implementation, the above step S204 of calculating the loss function value of the preset loss function based on the target training sample, the predicted seismic reflection coefficients, the predicted seismic wavelet, and the synthetic seismic recording data specifically includes following steps.

In step S2041, a mean squared error between the predicted seismic reflection coefficients and the sample seismic reflection coefficients in the target training sample is calculated to obtain a first error.

In step S2042, a mean squared error between the predicted seismic wavelet and the sample seismic wavelet in the target training sample is calculated to obtain a second error.

In step S2043, a mean squared error between the synthetic seismic recording data and the sample seismic recording data in the target training sample is calculated to obtain a third error.

In step S2044, the loss function value of the preset loss function is calculated based on the first error, the second error, and the third error.

Optionally, the preset loss function is expressed as: loss (s, r, w, r_{Label}, w_{Label})=λMSE(r, r_{Label})+μMSE(w,w_{Label})+φMSE(s,input).

Herein, s represents the synthetic seismic recording data, input represents the sample seismic recording data, r represents the predicted seismic reflection coefficients, r_{Label} represents the sample seismic reflection coefficients, w represents the predicted seismic wavelet, w_{Label} represents the sample seismic wavelet, MSE( ) represents a mean squared error loss function, and λ, μ, and φ all represent preset weight coefficients.

That is, MSE(r, r_{Label}) represents the first error, MSE(w, w_{Label}) represents the second error, and MSE(s, input) represents the third error. As can be known from the above description, the embodiment of the present disclosure proposes an interpretable blind inversion technology of seismic reflection coefficients based on the Transformer network under the premise of using a convolution model as a physical constraint.

To improve the generalization ability of the improved Transformer network model, when constructing the training sample set, the training sample set in the embodiment of the present disclosure includes both stationary seismic recording data and non-stationary seismic recording data. That is, the sample seismic recording data in the training sample set includes following two types: the stationary seismic recording data and the non-stationary seismic recording data. Based on this, when constructing the sample seismic recording data based on the sample seismic reflection coefficients and the sample seismic wavelet, it is necessary to select a corresponding convolution model according to the final desired stationary/non-stationary seismic recording data.

In an optional implementation, a convolution model for the stationary seismic recording data is expressed as: input₁(t)=w(t)*r(t)+n(t), where input₁(t) represents the stationary seismic recording data, r(t) represents the sample seismic reflection coefficients, w(t) represents the sample seismic wavelet, and n represents additive noise.

A convolution model for the non-stationary seismic recording data is expressed as:

$${input}_{2} ( t ) = {\int }_{0}^{+ ∞} r ( τ ) \frac{1}{2 π} {\int }_{- ∞}^{+ ∞} W ( f ) α ( τ , f ) {e}^{2 π if ( t - τ )} dfd τ ,$$

where input₂(t) represents the non-stationary seismic recording data, r(τ) represents seismic reflection coefficients at time τ in the sample seismic reflection coefficients, W(f) represents a Fourier transform of the sample seismic wavelet w(t), f represents frequency, α(τ, f) represents an attenuation function,

$$α ( τ , f ) = {e}^{- π f {\int }_{0}^{τ} \frac{1}{Q ( t )} dt} ,$$

Q(t) represents a stratum attenuation factor at time t, and i represents an imaginary unit.

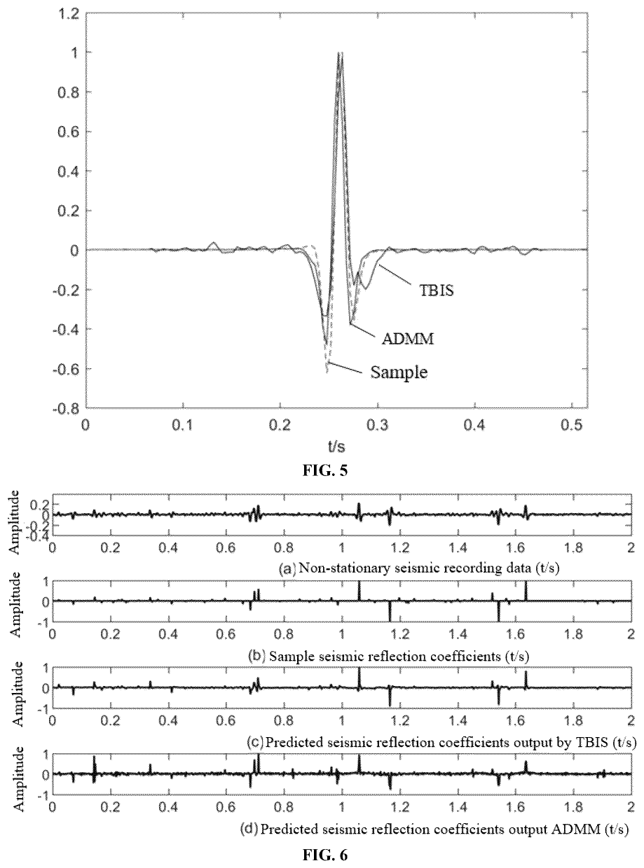

To verify the performance of the method of the present disclosure, the method (abbreviated as TBIS) provided in the embodiment of the present disclosure is compared with an existing alternating direction method of multipliers (ADMM). FIG. 4 is a schematic comparison diagram of seismic reflection coefficients obtained after inverting single-trace stationary seismic recording data. View (a) in FIG. 4 shows the stationary seismic recording data, view (b) in FIG. 4 shows the sample seismic reflection coefficients, view (c) in FIG. 4 is predicted seismic reflection coefficients output by the method (abbreviated as TBIS) provided in the embodiment of the present disclosure, and view (d) in FIG. 4 is predicted seismic reflection coefficients output by the alternating direction method of multipliers (ADMM). FIG. 5 is a schematic comparison diagram of seismic wavelets obtained after inverting single-trace stationary seismic recording data.

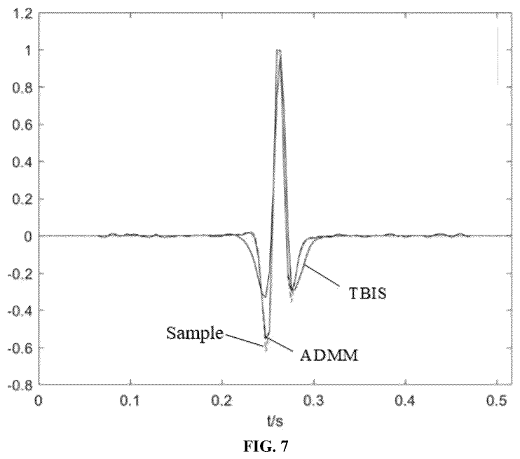

FIG. 6 is a schematic comparison diagram of seismic reflection coefficients obtained after inverting single-trace non-stationary seismic recording data. View (a) in FIG. 6 shows the non-stationary seismic recording data, view (b) in FIG. 6 shows the sample seismic reflection coefficients, view (c) in FIG. 6 shows predicted seismic reflection coefficients output by the method provided in the embodiment of the present disclosure, and view (d) in FIG. 6 shows predicted seismic reflection coefficients output by the alternating direction method of multipliers (ADMM). FIG. 7 is a schematic comparison diagram of seismic wavelets obtained after inverting single-trace non-stationary seismic recording data.

As can be seen from FIGS. 4 to 7, compared with the ADMM algorithm, the improved Transformer network model is able to achieve results with a higher resolution and a better signal-to-noise ratio for both stationary and non-stationary seismic recordings. Moreover, the improved Transformer network model may also estimate wavelets with different frequencies and phases, which match well with real wavelets.

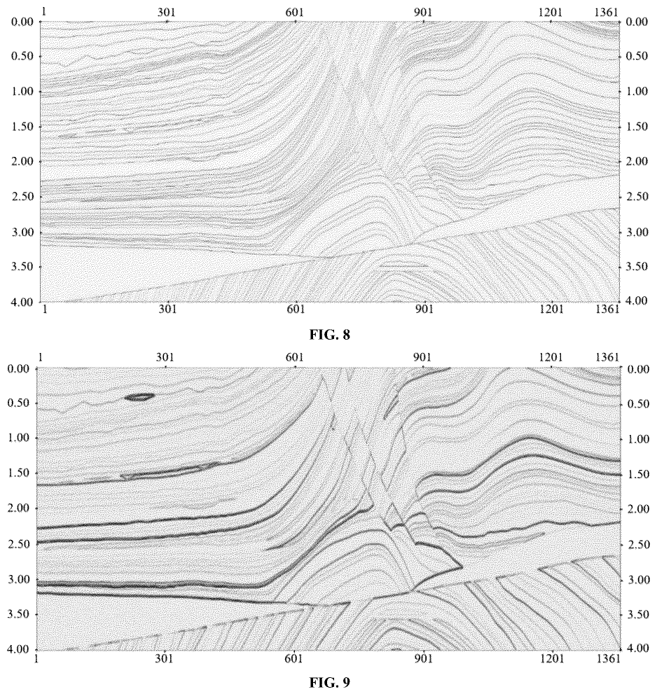

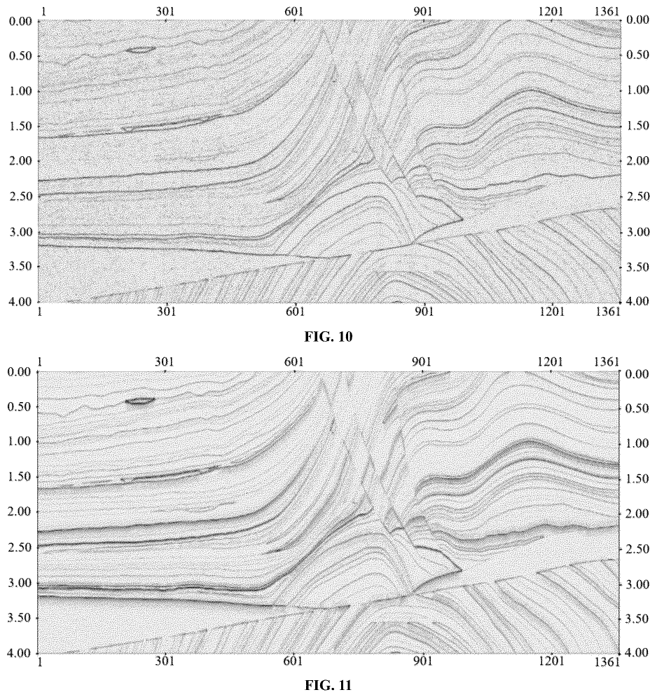

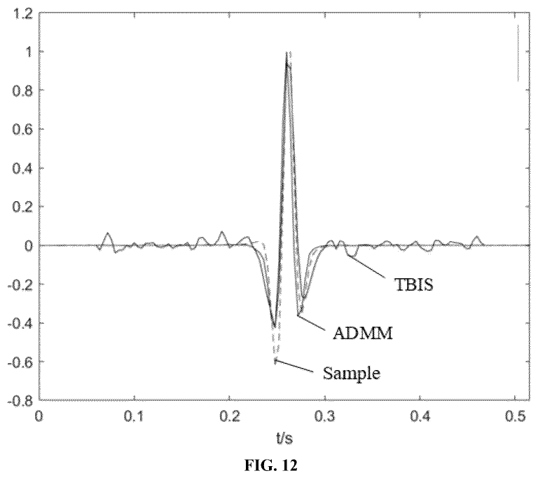

Further, the Marmousi model may further be used to generate a multi-trace seismic profile for comparison of algorithm performances. Optionally, the Marmousi model generates 2,301 traces of data. The improved Transformer network model performs single-trace test calculations on all traces of data, and high-resolution seismic results and wavelet estimation results may be obtained. As shown in FIGS. 8 to 12, FIG. 8 is a schematic diagram of seismic reflection coefficients generated by Marmousi model; FIG. 9 is a schematic diagram of sample seismic recording data obtained by convolving the seismic reflection coefficients in FIG. 8; FIG. 10 is a schematic diagram of predicted seismic reflection coefficients output after inverting FIG. 9 using the ADMM method; FIG. 11 is a schematic diagram of predicted seismic reflection coefficients output after inverting FIG. 9 using the method provided in the embodiment of the present disclosure; and FIG. 12 is a schematic comparison diagram of seismic wavelets obtained after inverting FIG. 9.

TABLE 1
Comparison of algorithm performances

| Algorithm | Run time | Error | Hardware |
|---|---|---|---|
| ADMM | 37 s | 0.0027 | CPU + MATLAB |
| TBIS | 26 s | 0.0005 | GPU + Pytorch |

As can be seen from FIGS. 8 to 12, the seismic profile calculated based on the improved Transformer network model has not only a higher resolution but also a higher signal-to-noise ratio. By comparing with a sequence of real reflection coefficients of the Marmousi model and combining with Table 1, it can be seen that the improved Transformer network model proposed in the embodiment of the present disclosure is able to make the output predicted seismic reflection coefficients well match the real reflection coefficients. Moreover, FIG. 12 shows that the improved Transformer network model may estimate wavelets of a multi-trace seismic record well.

In summary, in the embodiment of the present disclosure, based on the Transformer neural network and the seismic convolution model, a blind inversion neural network for the seismic reflection coefficients and the seismic wavelets is constructed, and this network uses the seismic convolution model as the physical constraint to enhance interpretability. After training the initial neural network model based on the training sample set to obtain a stable blind inversion network (i.e., the improved Transformer network model), the improved Transformer network model is able to derive results with a higher resolution and a better noise resistance than a traditional algorithm through inversion in seismic reflection coefficient inversion, without requiring any prior assumptions about sequence(s) of reflection coefficients and seismic wavelet(s) of a seismic record, a stratum attenuation Q-value model, etc. Moreover, the seismic wavelets estimated by the network show good matching results in both frequency and phase.

### Embodiment 2

The embodiment of the present disclosure further provides an apparatus for simultaneous inversion of seismic reflection coefficients and seismic wavelets, and the apparatus is mainly used to execute the method for simultaneous inversion of seismic reflection coefficients and seismic wavelets provided in Embodiment 1. The apparatus for the simultaneous inversion of seismic reflection coefficients and seismic wavelets provided in the embodiment of the present disclosure is specifically introduced below.

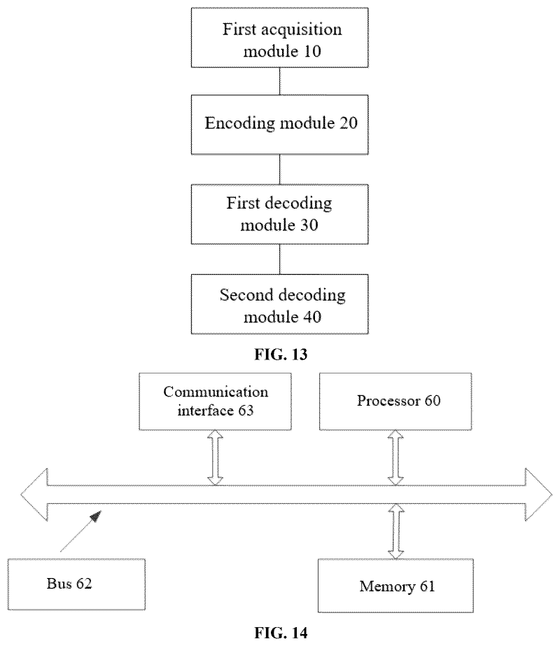

FIG. 13 is a diagram shows functional modules of an apparatus for simultaneous inversion of seismic reflection coefficients and seismic wavelets provided in an embodiment of the present disclosure. As shown in FIG. 13, the apparatus mainly includes a first acquisition module 10, an encoding module 20, a first decoding module 30, and a second decoding module 40.

The first acquisition module 10 is used to acquire seismic recording data of a specified work area and perform position encoding on the seismic recording data to obtain target seismic recording data.

The encoding module 20 is used to extract temporal and spatial characteristics of the target seismic recording data to obtain temporal and spatial characteristics of seismic wavelets and temporal and spatial characteristics of seismic reflection coefficients within the specified work area.

The first decoding module 30 is used to decode the temporal and spatial characteristics of the seismic reflection coefficients to obtain the seismic reflection coefficients of the specified work area.

The second decoding module 40 is used to decode the temporal and spatial characteristics of the seismic wavelets to obtain the seismic wavelets of the specified work area.

The embodiment of the present disclosure provides the apparatus for the simultaneous inversion of seismic reflection coefficients and seismic wavelets. This apparatus processes the seismic recording data of the specified work area using the improved Transformer network model. Since the model is provided with the seismic reflection coefficient decoder component and the seismic wavelet decoder component arranged in parallel after the encoder component, in the embodiment of the present disclosure, the seismic reflection coefficients and the seismic wavelets of the specified work area are able to be simultaneously derived through inversion. Considering that no prior assumptions about the seismic wavelets are required before inversion, the problem of error accumulation is avoided, thereby effectively solving the technical problem of low inversion accuracy of seismic reflection coefficients in the prior art.

Optionally, the apparatus further includes a second acquisition module, a processing module, a convolution module, a calculation module, and a training module.

The second acquisition module is used to acquire a training sample set. The training sample set includes a plurality of training samples, and each training sample includes sample seismic recording data, sample seismic reflection coefficients, and a sample seismic wavelet. The sample seismic recording data is a result obtained by convolution based on the sample seismic reflection coefficients and the sample seismic wavelet.

The processing module is used to process sample seismic recording data in a target training sample using an initial neural network model to obtain predicted seismic reflection coefficients and a predicted seismic wavelet. The target training sample represents any training sample in the training sample set.

The convolution module is used to convolve the predicted seismic reflection coefficients and the predicted seismic wavelet to obtain synthetic seismic recording data.

The calculation module is used to calculate a loss function value of a preset loss function based on the target training sample, the predicted seismic reflection coefficients, the predicted seismic wavelet, and the synthetic seismic recording data.

The training module is used to train the initial neural network model based on the loss function value until a preset termination condition is met, so as to obtain the improved Transformer network model.

Optionally, the calculation module is specifically used to:
calculate a mean squared error between the predicted seismic reflection coefficients and the sample seismic reflection coefficients in the target training sample to obtain a first error;
calculate a mean squared error between the predicted seismic wavelet and the sample seismic wavelet in the target training sample to obtain a second error;
calculate a mean squared error between the synthetic seismic recording data and the sample seismic recording data in the target training sample to obtain a third error; and
calculate the loss function value of the preset loss function based on the first error, the second error, and the third error.

Optionally, the preset loss function is expressed as: loss (s,r, W, r_{Label}, w_{Label})=λMSE(r,r_{Label})+μMSE(w,w_{Label})+φMSE(s,input), where s represents the synthetic seismic recording data, input represents the sample seismic recording data, r represents the predicted seismic reflection coefficients, r_{Label} represents the sample seismic reflection coefficients, w represents the predicted seismic wavelet, w_{Label} represents the sample seismic wavelet, MSE( ) represents a mean squared error loss function, and λ, μ, and φ all represent preset weight coefficients.

Optionally, the sample seismic recording data in the training sample set includes following two types: stationary seismic recording data and non-stationary seismic recording data.

Optionally, a convolution model for the stationary seismic recording data is expressed as: input₁(t)=w(t)*r(t)+n(t), where input (t) represents the stationary seismic recording data, r(t) represents the sample seismic reflection coefficients, w(t) represents the sample seismic wavelet, and n represents additive noise.

A convolution model for the non-stationary seismic recording data is expressed as:

$${input}_{2} ( t ) = {\int }_{0}^{+ ∞} r ( τ ) \frac{1}{2 π} {\int }_{- ∞}^{+ ∞} W ( f ) α ( τ , f ) {e}^{2 π if ( t - τ )} dfd τ ,$$

where input₂(t) represents the non-stationary seismic recording data, r(τ) represents seismic reflection coefficients at time τ in the sample seismic reflection coefficients, W(f) represents a Fourier transform of the sample seismic wavelet w(t), f represents frequency, α(τ, f) represents an attenuation function,

$$α ( τ , f ) = {e}^{- π f {\int }_{0}^{τ} \frac{1}{Q ( t )} dt} ,$$

Q(t) represents a stratum attenuation factor at time t, and i represents an imaginary unit.

### Embodiment 3

As shown in FIG. 14, the embodiment of the present disclosure provides an electronic device. The electronic device includes a processor 60, a memory 61, a bus 62, and communication interface 63. The processor 60, the communication interface 63, and the memory 61 are connected via the bus 62. The processor 60 is used to execute executable modules stored in the memory 61, such as computer programs.

The memory 61 may include a high-speed random access memory (RAM), and may also include a non-volatile memory, such as at least one magnetic disk storage. The system network element is communicatively connected to at least one other network element through at least one communication interface 63 (which may be wired or wireless), and the Internet, a wide area network, a local area network, a metropolitan area network, etc., may be used.

The bus 62 may be an ISA bus, a PCI bus, an EISA bus, or the like. The bus may be divided into an address bus, a data bus, a control bus, etc. For ease of representation, only one bidirectional arrow is shown in FIG. 14, but this does not indicate that there is only one bus or one type of bus.

The memory 61 is used to store programs, and the processor 60 executes the programs after receiving an execution instruction. The method executed by the apparatus defined in any of the foregoing embodiments of the present disclosure may be applied to the processor 60 or implemented by the processor 60.

The processor 60 may be an integrated circuit chip with a signal processing ability. During implementation, the steps of the above method may be completed by hardware integrated logic circuits or software instructions in the processor 60. The above processor 60 may be a general-purpose processor, including a central processing unit (CPU), a network processor (NP), etc., or may be a digital signal processor (DSP), an application specific integrated circuit (ASIC), a field-programmable gate array (FPGA), or other programmable logic device, discrete gate, or transistor logic device, discrete hardware component. The methods, steps, and logic block diagrams disclosed in the embodiments of the present disclosure may be implemented or executed. The general-purpose processor may be a microprocessor, or this processor may be any conventional processor, or the like. The steps of the method disclosed in the embodiments of the present disclosure may be directly implemented by a hardware decoding processor, or implemented by a combination of hardware and software modules in a decoding processor. The software module may be located in a mature storage medium in the art, such as a random access memory, a flash memory, a read-only memory, a programmable read-only memory, or an electrically erasable programmable memory, a register. The storage medium is located in the memory 61, and the processor 60 reads information in the memory 61 and completes the steps of the above method in combination with its hardware.

A computer program product of the method, apparatus, and electronic device for the simultaneous inversion of seismic reflection coefficients and seismic wavelets provided in the embodiments of the present disclosure includes a computer-readable storage medium storing a processor-executable non-volatile program code. Instructions included in the program code may be used to execute the method described in the foregoing method embodiment, and the specific implementation may refer to the method embodiment, which are not repeated here.

In addition, functional units in the various embodiments of the present disclosure may be integrated into a processing unit, or each unit may exist physically alone, or two or more units may be integrated into a unit.

If the functions are implemented in the form of software functional units and sold or used as an independent product, they may be stored in a processor-readable non-volatile computer-readable storage medium. Based on this understanding, the technical solution of the present disclosure, in essence, or a part thereof contributing to the prior art, or a part of the technical solution, may be embodied in the form of a software product. The computer software product is stored in a storage medium, and includes several instructions to make a computer device (which may be a personal computer, a server, a network device, etc.) execute all or part of the steps of the method described in the individual embodiments of the present disclosure. The foregoing storage medium include a medium that can store the program code, such as U disk, mobile hard disk, read-only memory (ROM), random access memory (RAM), magnetic disk, optical disk, or the like.

It should be noted that similar reference numerals and letters represent similar items in the following drawings. Therefore, once an item is defined in one drawing, it does not need to be further defined and explained in subsequent drawings.

In the description of the present disclosure, it should be noted that an orientation or positional relationship indicated by the term such as “center”, “upper”, “lower”, “left”, “right”, “vertical”, “horizontal”, “inside”, “outside” is based on an orientation or positional relationship shown in the drawings, or an orientation or positional relationship that a product of the present disclosure is usually placed in use, which is only for the convenience of describing the present disclosure and simplifying the description, rather than indicating or implying that the referred apparatus or element must have a specific orientation, be constructed and operated in a specific orientation, and thus cannot be understood as a limitation to the present disclosure. In addition, the term such as “first”, “second”, “third” is only used to distinguish the description, and cannot be understood as indicating or implying relative importance.

In addition, the term “horizontal”, “vertical”, “overhanging”, or the like do not mean that a component must be absolutely horizontal or overhanging, but may be slightly inclined. For example, “horizontal” merely means that its direction is more horizontal relative to “vertical”, and does not mean that the structure must be absolutely horizontal, but may be slightly inclined.

In the description of the present disclosure, it should also be noted that unless otherwise clearly specified and limited, the terms “arrange”, “install”, “connect”, and “link” should be interpreted broadly. For example, “connection” may be a fixed connection, a detachable connection, or an integral connection; may be a mechanical connection or an electrical connection; may be a direct connection, or an indirect connection through an intermediate medium; may be an internal communication between two elements. For those of ordinary skill in the art, the specific meanings of the above terms in the present disclosure may be understood according to specific situations.

Finally, it should be noted that the foregoing embodiments are only used to describe the technical solutions of the present disclosure, rather than a limitation to the present disclosure. Although the present disclosure has been described in detail with reference to the foregoing embodiments, those of ordinary skill in the art should understand that they may still modify the technical solutions recorded in the foregoing embodiments, or perform equivalent replacements for some or all of the technical features. These modifications or replacements do not make the essence of the corresponding technical solutions depart from the scope of the technical solutions of the individual embodiments of the present disclosure.

1. A method for simultaneous inversion of seismic reflection coefficients and seismic wavelets, wherein the method is applied to an improved Transformer network model, and the improved Transformer network model comprises an input layer, an encoder component, and a seismic reflection coefficient decoder component and a seismic wavelet decoder component arranged in parallel; and the method comprises:
acquiring, by the input layer, seismic recording data of a specified work area, and performing, by the input layer, position encoding on the seismic recording data to obtain target seismic recording data;
extracting, by the encoder component, temporal and spatial characteristics of the target seismic recording data to obtain temporal and spatial characteristics of seismic wavelets and temporal and spatial characteristics of seismic reflection coefficients within the specified work area;
decoding, by the seismic reflection coefficient decoder component, the temporal and spatial characteristics of the seismic reflection coefficients to obtain the seismic reflection coefficients of the specified work area; and
decoding, by the seismic wavelet decoder component, the temporal and spatial characteristics of the seismic wavelets to obtain the seismic wavelets of the specified work area.

2. The method for simultaneous inversion of seismic reflection coefficients and seismic wavelets according to claim 1, wherein the method further comprises:
acquiring a training sample set, wherein the training sample set comprises a plurality of training samples, and each training sample comprises sample seismic recording data, sample seismic reflection coefficients, and a sample seismic wavelet; and the sample seismic recording data is a result obtained by convolution based on the sample seismic reflection coefficients and the sample seismic wavelet;
processing sample seismic recording data in a target training sample using an initial neural network model to obtain predicted seismic reflection coefficients and a predicted seismic wavelet, wherein the target training sample represents any training sample in the training sample set;
convolving the predicted seismic reflection coefficients and the predicted seismic wavelet to obtain synthetic seismic recording data;
calculating a loss function value of a preset loss function based on the target training sample, the predicted seismic reflection coefficients, the predicted seismic wavelet, and the synthetic seismic recording data; and
training the initial neural network model based on the loss function value until a preset termination condition is met, so as to obtain the improved Transformer network model.

3. The method for simultaneous inversion of seismic reflection coefficients and seismic wavelets according to claim 2, wherein calculating the loss function value of the preset loss function based on the target training sample, the predicted seismic reflection coefficients, the predicted seismic wavelet, and the synthetic seismic recording data comprises:
calculating a mean squared error between the predicted seismic reflection coefficients and the sample seismic reflection coefficients in the target training sample to obtain a first error;
calculating a mean squared error between the predicted seismic wavelet and the sample seismic wavelet in the target training sample to obtain a second error;
calculating a mean squared error between the synthetic seismic recording data and the sample seismic recording data in the target training sample to obtain a third error; and
calculating the loss function value of the preset loss function based on the first error, the second error, and the third error.

4. The method for simultaneous inversion of seismic reflection coefficients and seismic wavelets according to claim 3, wherein the preset loss function is expressed as:
$$loss ( s , r , w , {r}_{Label} , {w}_{Label} ) = λ MSE ( r , {r}_{Label} ) + μ MSE ( w , {w}_{Label} ) + φ MSE ( s , input ) ,$$
where s represents the synthetic seismic recording data, input represents the sample seismic recording data, r represents the predicted seismic reflection coefficients, r_{Label} represents the sample seismic reflection coefficients, w represents the predicted seismic wavelet, w_{Label} represents the sample seismic wavelet, MSE( ) represents a mean squared error loss function, and λ, μ, and φ all represent preset weight coefficients.

5. The method for simultaneous inversion of seismic reflection coefficients and seismic wavelets according to claim 2, wherein the sample seismic recording data in the training sample set comprises following two types: stationary seismic recording data and non-stationary seismic recording data.

6. The method for simultaneous inversion of seismic reflection coefficients and seismic wavelets according to claim 5, wherein
a convolution model for the stationary seismic recording data is expressed as: input₁(t)=w(t)*r(t)+n(t), where input₁(t) represents the stationary seismic recording data, r(t) represents the sample seismic reflection coefficients, w(t) represents the sample seismic wavelet, and n represents additive noise; and
a convolution model for the non-stationary seismic recording data is expressed as:
$${input}_{2} ( t ) = {\int }_{0}^{+ ∞} r ( τ ) \frac{1}{2 π} {\int }_{- ∞}^{+ ∞} W ( f ) α ( τ , f ) {e}^{2 π if ( t - τ )} dfd τ ,$$
where input₂(t) represents the non-stationary seismic recording data, r(τ) represents seismic reflection coefficients at time τ in the sample seismic reflection coefficients, W(f) represents a Fourier transform of the sample seismic wavelet w(t), f represents frequency, α(τ, f) represents an attenuation function,
$$α ( τ , f ) = {e}^{- π f {\int }_{0}^{τ} \frac{1}{Q ( t )} dt} ,$$
Q(t) represents a stratum attenuation factor at time t, and i represents an imaginary unit.

7. An apparatus for simultaneous inversion of seismic reflection coefficients and seismic wavelets, comprising:
a first acquisition module, configured to acquire seismic recording data of a specified work area and perform position encoding on the seismic recording data to obtain target seismic recording data;
an encoding module, configured to extract temporal and spatial characteristics of the target seismic recording data to obtain temporal and spatial characteristics of seismic wavelets and temporal and spatial characteristics of seismic reflection coefficients within the specified work area;
a first decoding module, configured to decode the temporal and spatial characteristics of the seismic reflection coefficients to obtain the seismic reflection coefficients of the specified work area; and
a second decoding module, configured to decode the temporal and spatial characteristics of the seismic wavelets to obtain the seismic wavelets of the specified work area.

8. The apparatus for simultaneous inversion of seismic reflection coefficients and seismic wavelets according to claim 7, wherein the apparatus further comprises:
a second acquisition module, configured to acquire a training sample set, wherein the training sample set comprises a plurality of training samples, and each training sample comprises sample seismic recording data, sample seismic reflection coefficients, and a sample seismic wavelet; and the sample seismic recording data is a result obtained by convolution based on the sample seismic reflection coefficients and the sample seismic wavelet;
a processing module, configured to process sample seismic recording data in a target training sample using an initial neural network model to obtain predicted seismic reflection coefficients and a predicted seismic wavelet, wherein the target training sample represents any training sample in the training sample set;
a convolution module, configured to convolve the predicted seismic reflection coefficients and the predicted seismic wavelet to obtain synthetic seismic recording data;
a calculation module, configured to calculate a loss function value of a preset loss function based on the target training sample, the predicted seismic reflection coefficients, the predicted seismic wavelet, and the synthetic seismic recording data; and
a training module, configured to train the initial neural network model based on the loss function value until a preset termination condition is met, so as to obtain an improved Transformer network model.

9. An electronic device, comprising a memory and a processor, and the memory storing a computer program that is able to run on the processor, wherein the processor implements the steps of the method for simultaneous inversion of seismic reflection coefficients and seismic wavelets according to claim 1 when executing the computer program.

10. A computer-readable storage medium, storing computer instructions that, when executed by a processor, implement the method for simultaneous inversion of seismic reflection coefficients and seismic wavelets according to claim 1.
